(19) United States
(12) Patent Application Publication
(10) Pub. No.: US 2014/0022683 A1
(43) Pub. Date: Jan. 23, 2014

(54) DEVICE FOR PROTECTING ELECTRIC EQUIPMENT FROM OVERVOLTAGE AND LIGHTENING

(71) Applicant: Costruzioni Elettromeccaniche P. Torresan S.r.l., Sesto San Giovanni (IT)

(72) Inventor: Flavio Brasola, Roncello (IT)

(21) Appl. No.: 13/985,547

(22) PCT Filed: Feb. 22, 2012
(86) PCT No.: PCT/IB2012/050813

§ 371 Date: Oct. 9, 2013

(30) Foreign Application Priority Data
Feb. 22, 2011 (IT) M12011A000266

(51) Int. Cl. H02H 1/00; H02H 9/04

(52) U.S. Cl. CPC H02H 1/0007; H02H 9/041
USPC 361/91.2

(57) ABSTRACT

An electric equipment protection device includes a first conducting line and a second conducting line, connectable to a power source to receive a supply voltage of a rated value; at least one varistor, connected between the first conducting line and the second conducting line, and having a breakdown voltage; and a control stage cooperating with the varistor. The control stage includes at least one gas discharge device, an activation network of the gas discharge device and a diagnostic device.

### TECHNICAL FIELD

The present invention relates to a device for protecting electric equipment from lightening.

### BACKGROUND ART

The circuits for protecting electric equipment from lightening are generally based on the use of varistors, e.g. of the zinc oxide (ZnO) type. It is known that varistors are devices with strongly non-linear voltage-current characteristic, and generally have a high impendence state and a low impedance state. Under normal working conditions, if the voltage applied to the terminals of a varistor is lower than its breakdown voltage, the device is in high impedance state. When the breakdown voltage is exceeded, e.g. due lightening or overvoltage, the impedance drops and the varistor may draw high currents in the presence of modest voltage variations.

While being relatively effective in increasing the degree of protection of the equipment connected downstream of the varistor, the known devices have major limitations.

Firstly, even in high impendence state, the leakage currents of the varistors are however rather high, in general in the order of several milliamperes. In addition to energy consumption, currents of this magnitude may cause overheating and early aging of the varistors.

In order to reduce leakage currents, the varistors are overdimensioned, or more precisely the varistors are dimensioned so that their breakdown voltage is much higher than the rated working voltage of the protected equipment. However, this choice inevitably implies a lower protection effectiveness. In particular, the equipment may be exposed to voltages higher than the rated voltage, without the protection device intervening.

### DISCLOSURE OF INVENTION

It is an object of the present invention to provide an electric equipment protection device which allows to overcome the described limitations.

According to the present invention, an electric equipment protection device is provided as defined in claim 1.

### BRIEF DESCRIPTION OF THE DRAWINGS

Further features and advantages of the present invention will be apparent from the following description of a non-limitative embodiment thereof, with reference to the figures of the accompanying drawings, in which:

FIG. 1 is a simplified wiring diagram of an electric equipment protection device in accordance with a first embodiment of the present invention;

FIG. 2 is a chart showing magnitudes related to the protection device in FIG. 1;

FIG. 3 is a simplified wiring diagram of an electric equipment protection device in accordance with a second embodiment of the present invention;

FIG. 4 is a simplified wiring diagram of an electric equipment protection device in accordance with a third embodiment of the present invention;

FIG. 5 is a simplified wiring diagram of an electric equipment protection device in accordance with a fourth embodiment of the present invention;

FIG. 6 is a simplified wiring diagram of an electric equipment protection device in accordance with a fifth embodiment of the present invention;

FIG. 7 is a simplified wiring diagram of an electric equipment protection device in accordance with a sixth embodiment of the present invention;

FIG. 8 is a simplified wiring diagram of an electric equipment protection device in accordance with a seventh embodiment of the present invention; and

FIG. 9 is a simplified wiring diagram of an electric equipment protection device in accordance with an eighth embodiment of the present invention.

### BEST MODE FOR CARRYING OUT THE INVENTION

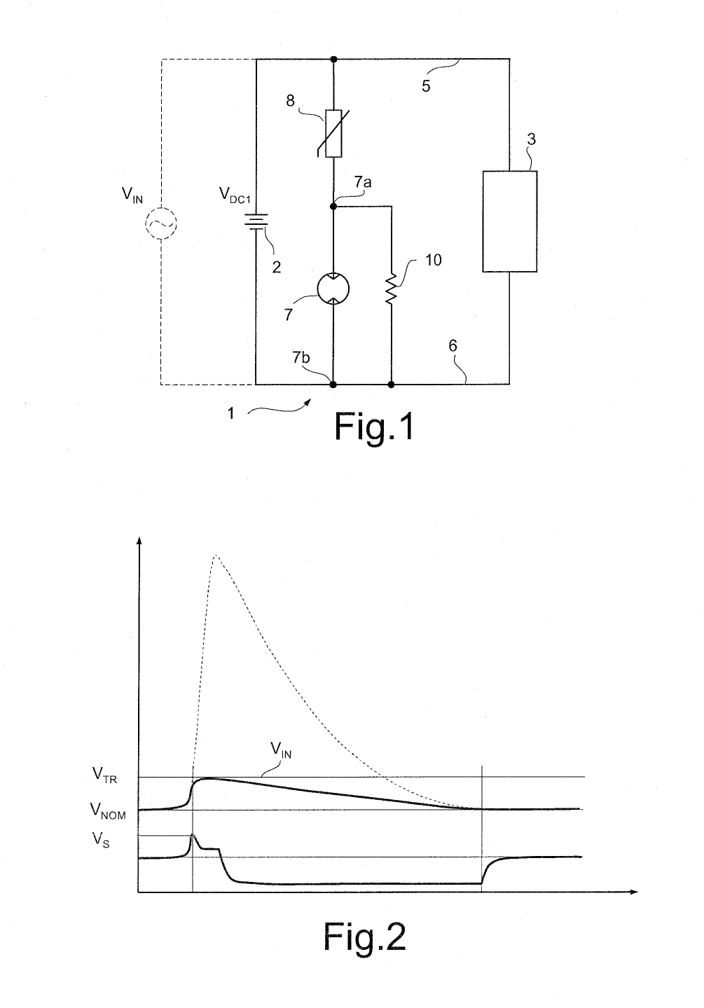

With reference to FIG. 1, reference numeral 1 indicates as a whole a protection device, which is arranged between a power source 2 and an electric equipment 3. In the example described, the electric equipment 3 requires a direct supply, which is provided by the power source 2.

The protection device 1 comprises a first power line 5, a second power line 6, a gas discharge device 7, a varistor 8 and an activation resistor 10.

The first power line 5 (positive polarity) and the second power line 6 (negative polarity) are connected to the power source 2 for receiving and transferring the power voltage V_{DC} to the electric equipment 3.

The gas discharge device 7 has a first terminal 7a connected to a terminal of the varistor 8 and a second terminal 7b connected to the second power line 6. The gas discharge device 7 has a high impedance state and a low impedance state. The transition from the high impendence state (which is the normal state of the gas discharge device 7) occurs when the voltage between the first terminal 7a and the second terminal 7b exceeds a threshold voltage V. The gas discharge device 7 then remains in the low impendence state until the voltage between the first terminal 7a and the second terminal 7b is cancelled or until the current drops under a maintenance value.

Varistor 8 is of the zinc oxide type, and is connected between the first power line 5 and the first terminal 7a of the gas discharge device 8. Thus, the gas discharge device gas 7 is coupled to the first power line 5 via varistor 8. Varistor 8 has a breakdown voltage V_{BD} lower than the rated value V_{NOM} of the power voltage V_{DC}. However, gas discharge device 7 and varistor 8 are chosen so that the sum of the threshold voltage V_{S} of the gas discharge device 7 and of the breakdown voltage V_{BD} of varistor 8 is higher than the rated value V_{NOM} of the power voltage V_{DC}.

The activation resistor 10 defines a network to activate the lightening protection and is connected between the first terminal 7a and the second terminal 7b of the gas discharge device 7.

The critical overvoltage value which determines the intervention of the protection may be programmed by means of the activation network, which in the described example is the activation resistor 10. In practice, the activation resistor 10 allows the protection to accurately intervene when the input voltage V_{IN} between the first power line 5 and the second power line 6 exceeds a trigger voltage V_{TR}. This condition occurs when an overvoltage (which is depicted by a variable voltage generator shown in a dashed line in FIG. 1), due to atmospheric lightening or interference, is superimposed to the power voltage V_{DC}. The resistance value R of the activation resistor may be selected so that the condition of exceeding the trigger voltage V_{TR} corresponds to the exceeding of the voltage threshold V_{S} of the gas discharge device 7.

In particular, the following relation should be satisfied:

V_{TR}=V_{R}(I_{TR})+V_{S}=V_{R}(I_{TR})+RI_{TR}=V_{R}(I_{TR})+RkV_{R}^{α}(I_{TR}) (1)

where V_{R}(I_{TR}) is the voltage drop on varistor 8 when a trigger current I_{TR} flows and causes the gas discharge device 7 to pass from the high impedance state to the low impedance state (i.e. in the presence of the trigger voltage V_{TR} between the first power line 5 and the second power line 6). Furthermore, k and α are experimental coefficients which define the current-voltage characteristic of varistor 8. In general, the following is obtained by indicating with I_{R} the current through the varistor:

I_{R}=kV_{R}^{α}(I_{R}) (2)

The following is obtained from relation (1):

$$R = \frac{{V}_{TR} - {V}_{R} ( {I}_{TR} )}{{kV}_{R}^{α} ( {I}_{TR} )} \qquad ( 3 )$$

Although equation (3) cannot be solved analytically due to the non-linearity of the current-voltage characteristic of varistor 8, determining numeric solutions is however convenient. The current-voltage characteristic of varistor 8 is in fact univocally determined once all parameters k and α, which are generally provided by the manufacturer or may be measured experimentally, are known.

In use, the gas discharge device 7 is normally in high impedance condition (and therefore it is practically in the off-state) and the voltage on varistor 8 is lower than the breakdown voltage V_{BD}. When an overvoltage occurs, e.g. caused by lightening, the voltage on the activation resistor 10 increases up to reach a threshold voltage V_{S}, which corresponds to the trigger voltage V_{TR} between the first power line 5 and the second power line 6. The gas discharge device 7 thus switches to low impedance state. The voltage between the first terminal 7a and the second terminal 7b is abated. The gas discharge device 7 is capable of drawing currents even in the order of several thousands of amperes without substantial voltage variations. Switching the gas discharge device 7 also causes the breakdown voltage V_{BD} of varistor 8 to be exceeded. Thereby, the overcurrent is drawn by the protection device 1 without consequences for the electric equipment 3 connected downstream. The breakdown threshold of the protection device 1 is accurately fixed at the trigger voltage V_{TR} by the activation network, which in the described embodiment is defined by the activation resistor 10 only.

The described protection device 1 has major advantages. Firstly, an optimal trade-off may be achieved, which effectively preserves both the safety of devices downstream of the protection device and the working life of the varistor. The passage of current under normal operating conditions is reduced to a few microamperes by virtue of the presence of the gas discharge device 7 and of the activation resistor 10. In addition to the energy consumption reduction, this would avoid the overheating of varistor 8, which would cause its early deterioration. The varistors are in fact made with zinc oxide granules embedded in resin. The overheating due to currents in the order of milliamperes causes, over time, a failure of the resin, which determines, in turn, an increase of the leakage current and the consequent temperature increase, thus compromising the operation of the varistor until failure due to thermal leakage is caused. Lower leakage currents thus imply a longer working life. Therefore, the varistors can be dimensioned with breakdown voltages lower than the rated value of the power voltage, thus exploiting the combination with the gas discharge device and the activation network. In particular, the activation network allows to accurately calibrate the trigger voltage where protection intervenes. In conventional devices, instead, the breakdown voltage of the varistors is normally overdimensioned, because leakages are so reduced. In this way, however, the protection intervenes at higher voltage levels, which may damage the downstream equipment or cause the early aging thereof.

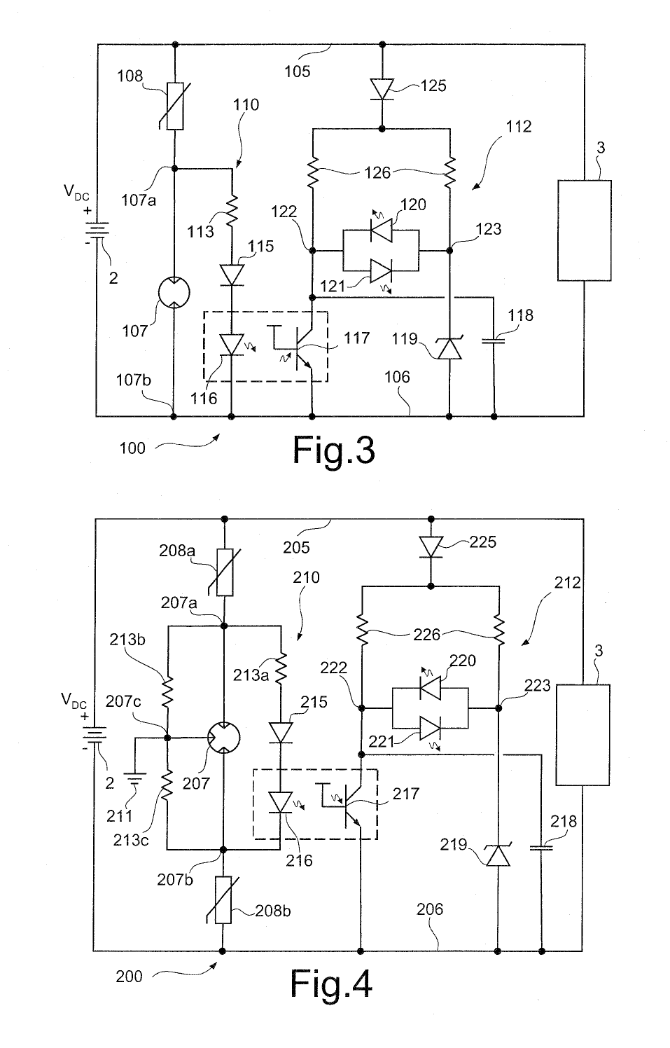

In the embodiment shown in FIG. 3, a protection device 100 is connected between the power source 2 and the electric equipment 3, and comprises a first power line 105, a second power line 106, a gas discharge device 107, a varistor 108, an activation network 110 and a diagnostic device 112. The activation network 110 and the diagnostic device 112 further define a control stage of varistor 108. As in the previous case, the gas discharge device 107 has a first terminal 107a connected to a terminal of varistor 108, and a second terminal 107b connected to the second power line 106; and the varistor 108 is connected between the first power line 105 and the first terminal 107a of the gas discharge device 107.

The activation network 110 comprises an activation resistor 113 and a directional diode 115 series-connected between the first terminal 107a and the second terminal 107b of the gas discharge device 107.

An emitter diode or emitter diode 116, which forms part of the diagnostic device 112, is series-connected to the directional diode 115.

In addition to the emitter diode 116, the diagnostic device 112 comprises a photodetector device, which in the described embodiment is a phototransistor 117; a driving network, which includes a capacitor 118, a zener diode 119, a diode 125 and resistors 126; a first signaling LED 120 and a second signaling LED 121.

The phototransistor 117, here of the NPN type, has a collector terminal connected to a first driving node 122 and an emitter terminal connected to the second power line 106 and is optically coupled to the emitter diode 116.

Capacitor 118 is connected between the first driving node 122 and the second power line 106.

The zener diode 119 has cathode terminal connected to a second driving node 123 and anode terminal connected to the second power line 106.

The first signaling LED 120 and the second signaling LED 121 are anti-parallel connected between the first driving node 122 and the second driving node 123.

The diode 125 and the two resistors 126 connect the first driving node 122 and the second driving node 123 to the first power line 105. More precisely, the diode has anode terminal connected to the first power line 105 and cathode terminal connected to a common terminal of the two resistors 126, which have further terminals connected to the first driving node 122 and to the second driving node 123, respectively.

In this case, the activation network 110 is configured to cause the gas discharge device 107 to switch on symmetrically. In the presence of positive interference, indeed, the activation of the gas discharge device 107 is essentially determined by the activation resistor 113, as already explained with reference to FIG. 1. If instead, an overvoltage with a polarity opposite to the input voltage V_{IN} occurs, the directional diode 115 prevents the current from passing through the activation resistor 113 and the gas discharge device 107 switches on when the voltage on the gas discharge device 107 reaches the trigger voltage Vs. The protection is thus activated by the trigger voltage V_{S} of the gas discharge device 107 (which is lower than the trigger voltage V_{TR}), because loads supplied with direct current often poorly tolerate even short lasting, transient reverse voltages.

The diagnostic device 112 provides an immediate reading of the actual state of varistor 108 signaling when a degradation threshold which requires replacement is reached. As mentioned, the phototransistor 117 is optically coupled to the emitter diode 116 and thus conducts a current I_{T} which is substantially proportional to the intensity of the light emitted by the light emitter diode 116, which in turn is correlated with the impedance of varistor 108. More precisely, the variations of the current flowing to the emitter diode 116 are substantially due to impedance variations of varistor 108, which is the component most subject to degradation. Emitter diode 116 and phototransistor 117 thus form an impedance detection circuit which provides a signal (i.e. the current I_{T} through phototransistor 117) indicative of the impedance the of the varistor 108.

When the varistor 108 is under regular operating conditions, the emitter diode 116 is sufficiently polarized to maintain the current I_{T} through the phototransistor 117, which remains in on-state with a low voltage drop between the collector and emitter terminals. The zener diode 119 is thus in off-state. Under these conditions, the first signaling diode 120 is in on-state, while the second signaling diode 121 is in off-state.

When the varistor 108 degrades, its impedance increases, thus reducing the current flowing through the emitter diode 116. The radiation provided by the emitter diode 116 is no longer sufficient to maintain the phototransistor 117 on, which is set to the off-state and allows the capacitor 118 to be charged up to the reverse breakdown voltage of the zener diode 119. Under these conditions, the first signaling diode 120 is in the off-state, while the second signaling diode 121 is in the on-state. Thus, in practice, the first signaling diode 120 indicates the correct operation of the protection device 1, while the second signaling diode 121 signals degradation conditions of the varistor 108.

According to the embodiment shown in FIG. 4, a protection device 200 is connected between the power source 2 and the electric equipment 3, and comprises a first power line 205, a second power line 206, a gas discharge device 207, a first varistor 208a, a second varistor 208b, an activation network 210 and a diagnostic device 212.

The gas discharge device 207 has a first terminal 207a connected to the first power line 205 through the first varistor 208a, a second terminal 207b connected to the second power line 206 through the second varistor 208b, and a third terminal 207c connected to a ground line 211.

The activation network 210 comprises an activation resistor 213a, a second activation resistor 213b, a third activation resistor 213c and a directional diode 215, series-connected to the first activation resistor 213a.

The first activation resistor 213a, with the directional diode 215 in series, is connected between the first terminal 207a and the second terminal 207b of the gas discharge device 207; the second activation resistor 213b is connected between the first terminal 207a and the third terminal 207c; and the third activation resistor 213c is connected between the second terminal 207b and the third terminal 207c.

The diagnostic device 212 comprises: an emitter diode 216 (series-connected to the directional diode 215); a phototransistor 217 coupled to the emitter diode 216; a driving network, including a capacitor 218, a zener diode 219, a diode 225 and two resistors 226; a first signaling LED 220 and a second signaling LED 221, anti-parallel connected between a first driving node 222 and a second driving node 223. The configuration and operation of the diagnostic device 212 of the embodiment of FIG. 4 are entirely similar to the configuration and operation of the diagnostic device 112 already described with reference to FIG. 3 and for this reason they will not be described in further detail.

The activation network 210 provides a balanced protection with respect to the ground line 211, by virtue of the connection of the third terminal 207c of the gas discharge device 207 and to the presence of the second resistor 213b and of the third resistor 213c. In particular, in the presence of common overvoltages with respect to the ground line 211, the activation network 210 allows however to have the gas discharge device 207 switch to the low impedance state in a timely manner. Furthermore, the maximum voltage is limited with respect to the ground line 211, thus increasing safety. The embodiment in FIG. 4 is particularly adapted to be used when the power source 2 is of the photovoltaic type.

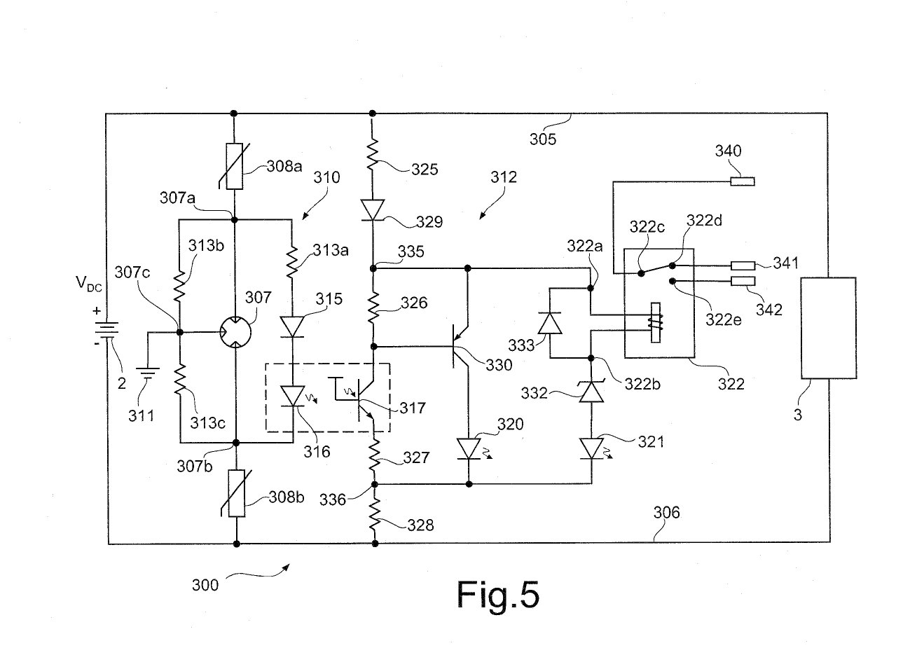

With reference to FIG. 5, a protection device 300 is connected between the power source 2 and the electric equipment 3, and comprises a first power line 305, a second power line 306, a gas discharge device 307, a first varistor 308a, a second varistor 308b, an activation network 310 and a diagnostic device 312.

The gas discharge device 307 has a first terminal 307a connected to the first power line 305 through the first varistor 308a, a second terminal 307b connected to the second power line 306 through the second varistor 308b and a third terminal 307c connected to a ground line 311.

The activation network 310 comprises a first activation resistor 313a, a second activation resistor 313b, a third activation resistor 313c and a directional diode 315, series-connected to the first activation resistor 313a.

The first activation resistor 313a, with the directional diode 315 in series, is connected between the first terminal 307a and the second terminal 307b of the gas discharge device 307; the second activation, resistor 313b is connected between the first terminal 307a and the third terminal 307c; and the third activation resistor 313c between the second terminal 307b and the third terminal 307c.

The diagnostic device 312 comprises an emitter diode 316, series-connected to the activation resistor 313a and to the directional diode 315, a phototransistor 317 optically coupled to the emitter diode 316, a driving network 312, a first signaling LED 320, a second signaling LED 321 and a relay 322, which in the example shown is of the SPDT type.

The driving network 312 comprises four driving resistors 325-328, a directional diode 329, a driving transistor 330, a zener diode 332 and a protection diode 333.

The driving resistor 325 is connected between the first power line 305 and an anode terminal of the directional diode 329, a cathode terminal of which is connected to a first driving node 335. The driving resistor 326 is connected between the first driving node 335 and a collector terminal of the phototransistor 317.

The driving resistor 327 is connected between an emitter terminal of the phototransistor 317 and a second driving node 336. The driving resistor 328 is connected between the second driving node 336 and the second power line 306.

The driving transistor 330, of PNP type, has emitter terminal connected to the first control node 335, collector terminal connected, via the first signaling LED 320, to the second control node 336 and base terminal connected to the collector terminal of the phototransistor 317. The driving resistor 326 is thus connected between the emitter and base terminals of the driving transistor 330.

The protection diode 333 has cathode terminal connected to the first driving node 335 and anode terminal connected to the cathode terminal of the zener diode 332. Furthermore, the protection diode 333 is connected between control terminals 322a, 322b of relay 322.

The zener diode 332 has anode terminal connected to the anode terminal of the second signaling LED 321, a cathode terminal of which is connected to the second driving node 336.

The relay 322 has conducting terminals 322c, 322d, 322e connected to respective contacts 340, 341, 342 for the remote connection to a signaling device (not shown here). The relay 322 has a first state, in the absence of excitation current between the control terminals 322a, 322b, in which the conducting terminal 322c is connected to the conducting terminal 322d; and a second state, when an excitation current is present between the control terminals 322a, 322b, in which the conducting terminal 322c is connected to the conducting terminal 322e.

When the first varistor 307a and the second varistor 308b are under normal operating conditions, the current flowing through the emitter diode 316 is sufficient to maintain the phototransistor 317 on, which in turn sets the driving transistor 330 to the on-state. Therefore, under these conditions, the first signaling LED 320 is on, while the second signaling LED 321 is off. Furthermore, no current is supplied to the control terminals 322a, 322b of relay 322. The relay 322 is thus in the first state. When at least one of the first varistor 307a and the second varistor 308b is subject to degradation, the current through the emitter diode 316 decreases and turns off the phototransistor 317, and therefore the driving transistor 330 and the first signaling LED 320. The voltage between the first driving node 335 and the second driving node 336 increases until the reverse breakdown current of the zener diode 332, which is set to the on-state, is exceeded. At this point, the second signaling LED 321 is on and a current is supplied to the control terminals 322a, 322b of the relay 322, which switches thus allowing the malfunction to be remotely signalled.

In an alternative embodiment (not shown), the first and second signaling LEDs are connected to respective conducting terminals of the relay, while the remaining conducting terminal is connected to the first power line. The relay is controlled according to the current which flows through the emitter diode so as to selectively activate one of the first and second signaling LEDs according to the impendence of one or more varistors.

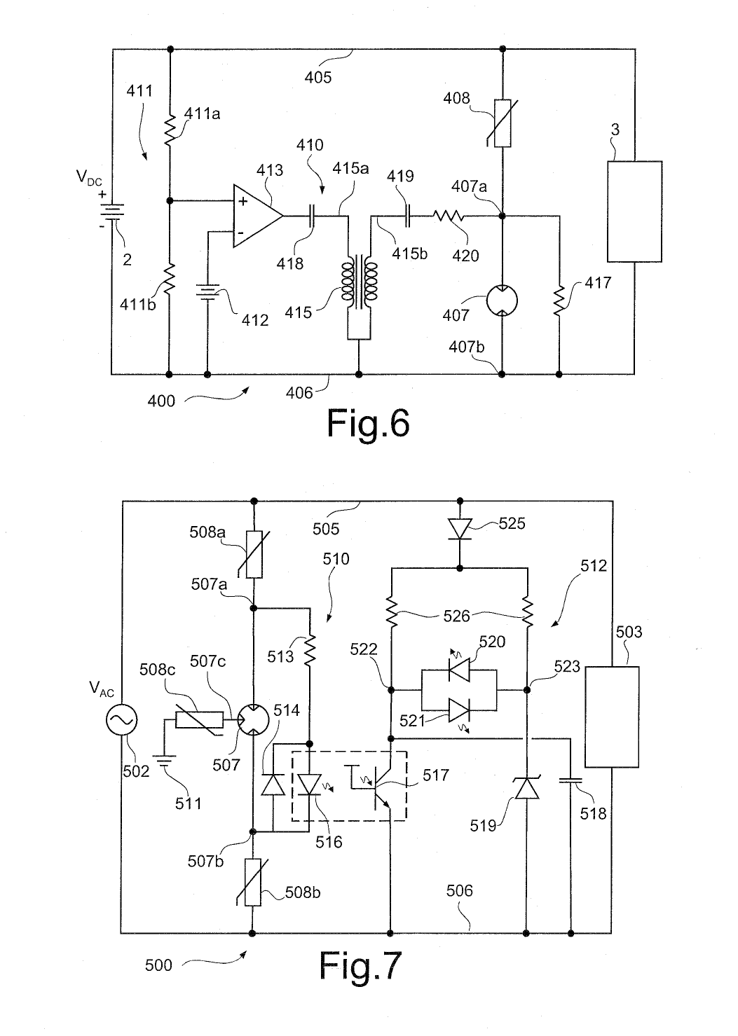

FIG. 6 shows an embodiment according to which a protection device 400 is connected between the power source 2 and the electric equipment 3, and comprises a first power line 405, a second power line 406, a gas discharge device 407, a varistor 408 and an activation network 410.

The gas discharge device 407 has a first terminal 407a connected to a terminal of the varistor 408 and a second terminal 407b connected to the second power line 406.

The varistor 408 is connected between the first power line 405 and the first terminal 407a of the gas discharge device 407. Therefore, the gas discharge device 407 is coupled to the first power line 405 via the varistor 408.

The activation network 410 comprises a resistive divider 411, a reference voltage source 412, a comparator 413, a booster transformer 415 and an activation resistor 417.

The resistive divider 411 is connected between the first power line 405 and the second power line 406, and comprises two resistors 411a, 411b.

The comparator 413 has a first (non-inverting) input connected to a common terminal of the resistors 411a, 411b and a second (inverting) input connected to the reference voltage source 412, which may be a reverse-biased zener diode, for example.

The output of comparator 413 is connected to a terminal 415a of the booster transformer 415 via a filter capacitor 418. A boosted terminal 415b of the booster transformer 415 is connected to the first terminal of the gas discharge device 407 via a filter capacitor 419 and a resistor 420.

The activation resistor 417 is connected between the first terminal 407a and the second terminal 407b of the gas discharge device 407.

When the input voltage exceeds the trigger voltage (determined by the reference voltage source 412), the comparator 413 drives the booster transformer 415 so as to take the voltage between the first terminal 407a and the second terminal 407b of the gas discharge device 407 to a level which is higher than the threshold voltage, thus switching the gas discharge device 407 itself.

By virtue of the use of comparator 413 and booster 415, the triggering of the gas discharge device 407 occurs however in a rapid and accurate manner when the trigger voltage is reached. Furthermore, the activation resistor 417 may be dimensioned to further reduce the leakage currents during normal operation, without affecting the effectiveness of the protection.

According to a further embodiment of the invention, shown in FIG. 7, a protection device 500 is connected between a power source 502, providing an alternating mono-phase power voltage V_{AC} and an electric equipment 503. The protection device 500 comprises a first power line 505, a second power line 506, a gas discharge device 507, a first varistor 508a, a second varistor 508b, a third varistor 508c, an activation network 510 and a diagnostic device 512.

The gas discharge device 507 has a first terminal 507a connected to the first power line 505 via the first varistor 508a, a second terminal 507b connected to the second power line 506 via the second varistor 508b, and a third terminal 507c connected to a ground line 511 via a third varistor 508c.

The activation network 510 comprises an activation resistor 513, connected between the first terminal 507a and the second terminal 507b of the gas discharge device 507, and a diode 514.

The diagnostic device 512 is similar to the diagnostic devices 112 in FIGS. 3 and 212 in FIG. 4, and comprises: an emitter diode 516; a phototransistor 517 coupled to the emitter diode 516; a driving network, which includes a capacitor 518, a zener diode 519, a diode 525 and two resistors 526; a first signaling LED 520 and a second signaling LED 521, anti-parallel connected between a first driving node 522 and a second driving node 523.

As in the previously described embodiments, the emitter diode 516 is connected between the activation resistor 513 and the second terminal 507b of the gas discharge device 507. Furthermore, in this case, the diode 514 is anti-parallel connected to the diagnostic LED 516, so as to allow the gas discharge device 507 to be symmetrically activated for lightening shocks of opposite polarity.

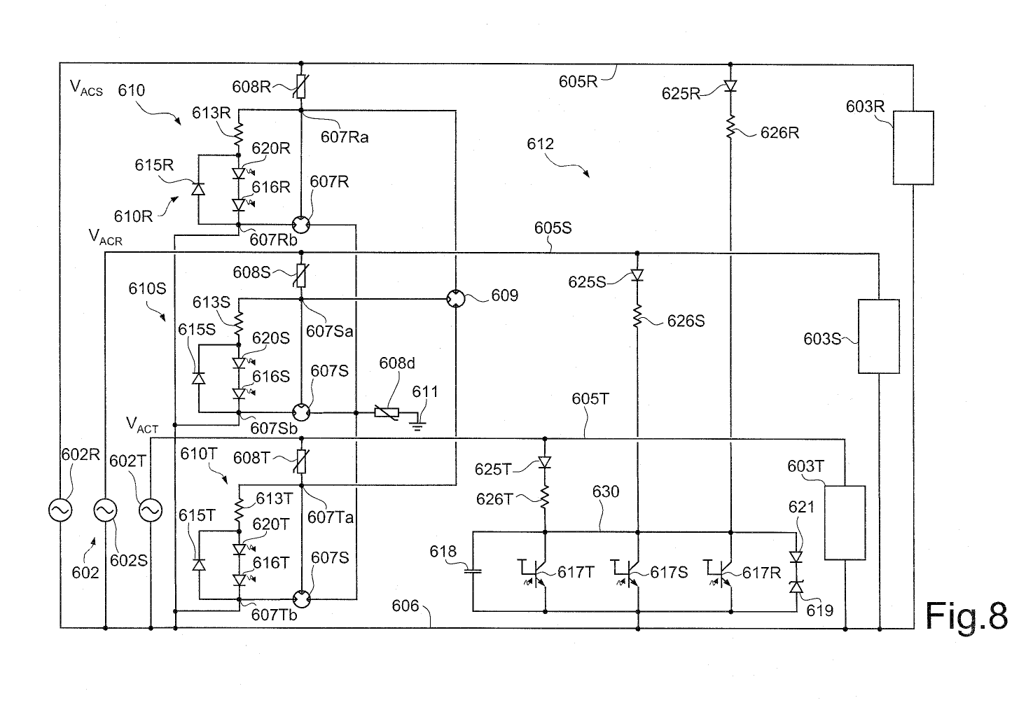

FIG. 8 shows a protection device 600 in accordance with a further embodiment of the invention and useable for three-phase systems with neutral line and protective ground.

The protection device 600 is arranged between a power source 602, supplying a three-phase star-connected power voltage V_{ACS}, V_{ACR}, V_{ACT} (the three phases are indicated with references 602R, 602S, 602T), and a three-phase electric equipment 603R, 603S, 603T and comprises: a first power line 605R, a second power line 605S, a third power line 605T and a neutral line 606; a first gas discharge device 607R, a second gas discharge device 607S, a third gas discharge device 607T and an auxiliary gas discharge device 609; a first varistor 608R, a second varistor 608S, a third varistor 608T and a fourth varistor 608d; an activation network 610 and a diagnostic device 612.

The first gas discharge device 607R has a first terminal 607Ra connected to the first power line 605R via the first varistor 608R and a second terminal 607Rb connected to the neutral line 606.

Similarly, the second gas discharge device 607S has a first terminal 607Sa connected to the second power line 605S via the second varistor 608S and a second terminal 607Sb connected to the neutral line 606; and the third gas discharge device 607T has a first terminal 607Ta connected to the third power line 605T via the third varistor 608T and a second terminal 607Tb connected to the neutral line 606.

Furthermore, the first terminals 607Ra, 607Sa, 607Ta of the first gas discharge device 607R, of the second gas discharge device 607S and of the third gas discharge device 607T are connected to respective terminals of the auxiliary gas discharge device 609; and third terminals of the first gas discharge device 607R, of the second gas discharge device 607S and of the third gas discharge device 607T are connected to a ground line 611 via the varistor 608d.

The activation network 610 comprises three identical branches 610R, 610S, 610T. Similarly, the diagnostic device 612 also has three identical branches 612R, 612S, 612T, and further comprises a capacitor 618, a zener diode 619 and a signaling LED 621.

For simplicity, only branch 610R of the activation network 610 and branch 612R of the diagnostic device 612 will be described hereinafter. It is understood that branches 610S and 610T of the activation network 610 and branches 612S and 612T have the same structure, except naturally for the fact that the branches 610S and 610T are coupled to the second gas discharge device 607S and to the third gas discharge device 607T, respectively.

The branch 610R of the activation network 610 comprises an activation resistor 613R and a directional diode 615R. The activation resistor 613R is connected between the first terminal 607Ra and the second terminal 607Rb of the first gas discharge device 607R via an emitter diode 616R and a signaling LED 620R in series, which belong to the branch 612R of the diagnostic device 612. The directional diode 615R has the anode terminal connected to the second terminal 607Rb of the first gas discharge device 607R and the cathode terminal connected to the activation resistor 613R.

In addition to the emitter diode 616R and to the signaling LED 620R, the branch 612R of the diagnostic device 612 comprises a phototransistor 617R, a diode 625R and a resistor 626R.

The phototransistor 617R is optically coupled to the emitter diode 616R and has emitter and collector terminals connected to the neutral line 606 and to a driving node 630 in common to the three branches 612R, 612S, 612T of the diagnostic device 612, respectively (in practice, the branches 612S, 612T comprise respective phototransistors 617S, 617T having collector terminals connected to the driving node 630).

Diode 625R and resistor 626R are series-connected between the first power line 605R and the driving node 630.

The capacitor 618 is connected between the driving node 630 and the neutral line 606 and, with the zener diode 619, the diode 625R and the resistor 626R, forms a driving network portion for the signaling LED 621 (the driving network further comprises diodes 625S, 625T and resistors 626S, 616T on the remaining phases).

The signaling LED 621 has anode terminal connected to the driving node 630 and cathode terminal connected to a cathode terminal of the zener diode 619, an anode terminal of which is connected to the neutral line 606.

The protection device acts independently on each phase. The gas discharge devices 607R, 607S, 607T switch to the low impedance state when between the respective power lines 605R, 605S, 605T and the neutral line 606 or the ground line 611 there is a voltage higher than the trigger voltage. The configuration with the auxiliary gas discharge device 609 allows the protection device 600 to work on the line-line protection as if a single gas discharge device with four terminals were used (such devices are not available today).

The diagnostic device 612 works as follows. Under normal operative conditions, the currents flowing through the emitter diodes 616R, 616S, 616T in the respective positive half-waves are sufficient to maintain the corresponding phototransistors 617R, 617S, 617T on, which keep the signaling LED 621 in the off-state, each for a respective portion of the period of the power source 602 (it is worth noting that the phototransistors 617R, 617S, 617T are in any case in the off-state during the negative half-waves of the corresponding phases 602R, 602S, 602T, regardless of the conditions of the varistors 608R, 608S, 608T). In contrast, the signaling LEDs 620R, 620S, 620T are on.

When one of the varistors 608R, 608S, 608T degrades, the current in the corresponding emitter diode 616R, 616S, 616T tends to be reduced and is not capable of maintaining the respective phototransistor 617R, 617S, 617T in the on-state. The capacitor 618 is thus charged to the reverse breakdown voltage of the zener diode 619 during the positive half-wave of the corresponding phase 602R, 602S, 602T, and causes the signaling LED 621 to switch on. The switching on of the signaling LED 621 and the simultaneous switching off of one of the signaling LEDs 620R, 620S, 620T allow to signal a malfunction, but also to identify which of the varistors 608R, 608S, 608T needs to be replaced.

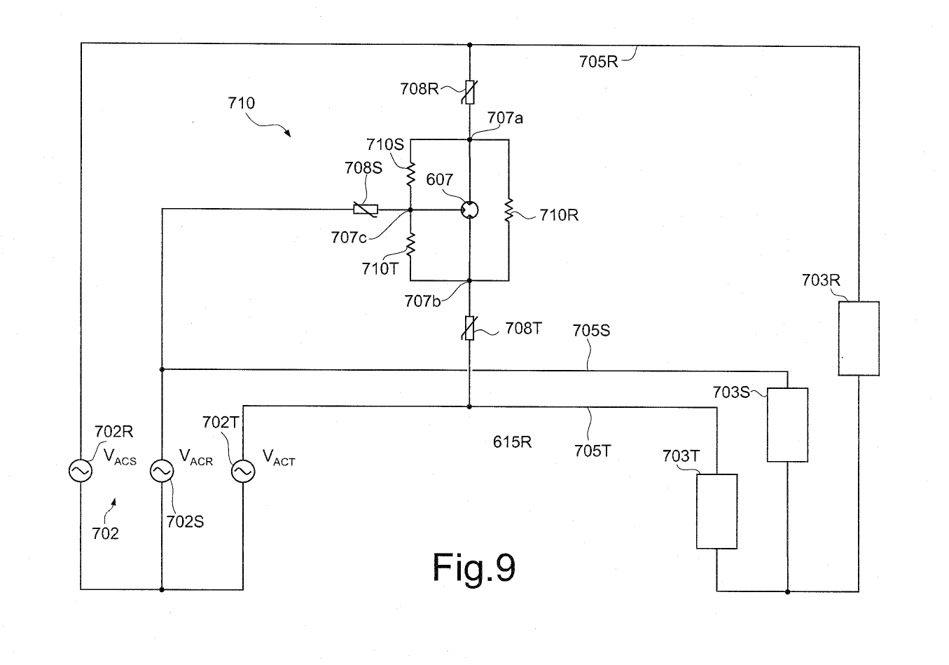

In the embodiment shown in FIG. 9, a protection device 700 is connected between a power source 702, providing a three-phase star-connected power voltage V_{ACS}, V_{ACR}, V_{ACT}, and an electric equipment 703, and comprises: a first phase line 705R, and second phase line 705S and a third phase line 705T; a gas discharge device 707 having a first terminal 707a, a second terminal 707b and a third terminal 707c; a first varistor 708R, a second varistor 708S and a third varistor 708T; and an activation network 710.

Each of the varistors 708R, 708S, 708T is connected between a respective terminal of the gas discharge device 707 and a respective phase line 705R, 705S, 705T.

The activation network 710 comprises a first activation resistor 710R, connected between the first terminal 707a and second terminal 707b of the gas discharge device 707; a second activation resistor 710S, connected between the first terminal 707a and the third terminal 707c of the first gas discharge device 707; and a third activation resistor 710T, connected between the second terminal 707b and the third terminal 707c of the first gas discharge device 707.

It is finally apparent that changes and variations may be made to the protection device according to the present invention, without departing from the scope of the appended claims.

In particular, in the embodiments in FIGS. 1, 6 and 9, the diagnostic device which may be apparently included has not been described for simplicity.

1-22. (canceled)

23. An electric equipment protection device comprising:
a first conducting line and a second conducting line, both connectable to a power source for receiving a supply voltage having a rated value;
at least a first varistor, connected between the first conducting line and the second conducting line, and having a breakdown voltage; and
a control stage cooperating with the first varistor.

24. A device according to claim 23, wherein the control stage comprises a diagnostic device, including:
a signaling circuit configured to alternatively signal a correct operating state or a malfunctioning state of the protection device;
an impedance detection circuit, configured to detect an impedance of the first varistor; and
a driving network, coupled to the detection circuit and configured to drive the signaling circuit as a function of the impedance of the first varistor.

25. A device according to claim 24, wherein the signaling circuit has a first state and a second state and the driving network is configured to set the signaling circuit to the first state, when the impedance of the first varistor is lower than a threshold, and to the second state when the impendence of the first varistor is higher than the threshold.

26. A device according to claim 25, wherein the detection circuit comprises:
a photoemitter device, series-connected to the first varistor, so as to emit a radiation of an intensity related to the current flowing through the first varistor; and
a photodetector optically coupled to the photoemitter and electrically coupled to the signaling circuit, so as to drive the signaling circuit according to the current flowing through the first varistor.

27. A device according to claim 24, comprising a plurality of conducting lines and a plurality of varistors, connected between respective pairs of conducting lines;
wherein the detection circuit comprises a plurality of photoemitter devices series-connected to respective varistors, so as to emit a radiation of intensity correlated to the currents flowing through the respective varistors; and
a plurality of photodetectors, optically coupled to respective photoemitter devices, and electrically coupled to the signaling circuit, so as to drive the signaling circuit according to the currents flowing through the respective varistors.

28. A device according to claim 24, wherein the signaling circuit comprises at least a first LED and a second LED, which are controlled by the driving network so as to be selectively set to an off-state or to an on-according to the current flowing through the first varistor.

29. A device according to claim 24, wherein the signaling circuit comprises a controlled two-position selector.

30. A device according to claim 29, wherein the controlled two-position selector is an SPDT relay.

31. A device according to claim 23, wherein:
the control stage comprises at least a first gas discharge device, having a first state with high impendence and a second state with low impendence, and a threshold voltage;
the first gas discharge device is connected between the first conducting line and the second conducting line via the first varistor;
the breakdown voltage of the first varistor is lower than the rated voltage, and the sum of the breakdown voltage of the first varistor and of the threshold voltage of the first gas discharge device is higher than the rated voltage; and
the control stage is configured so that the switching of the gas discharge device from the first state to the second state causes the breakdown voltage of the first varistor to be exceeded.

32. A device according to claim 31, wherein the control stage comprises an activation network, cooperating with the first varistor to supply an operating voltage higher than the threshold voltage to the terminals of the first gas discharge device, in response to an input overvoltage between the first conducting line and the second conducting line which is higher than a trigger voltage.

33. A device according to claim 32, wherein the activation network comprises a first activation resistor connected between two terminals of the first gas discharge device.

34. A device according to claim 33, comprising a second varistor, and wherein the first varistor is connected between a first terminal of the first gas discharge device and the first conducting line, and the second varistor is connected between a second terminal of the first gas discharge device and the second conducting line.

35. A device according to claim 33, comprising a third varistor connected between a third terminal of the first gas discharge device and a reference potential line.

36. A device according to claim 34, comprising a third conducting line, and a third varistor, connected between a third terminal of the first gas discharge device and the third conducting line.

37. A device according to claim 36, wherein the activation network comprises a second activation resistor connected between the first terminal and third terminal of the first gas discharge device, and a third activation resistor connected between the second terminal and third terminal of the first gas discharge device.

38. A device according to claim 33, comprising a reference potential line;
and wherein:
the first gas discharge device has a first terminal and a second terminal;
the activation network comprises a second activation resistor and a third activation resistor;
the first activation resistor is connected between the first terminal and second terminal of the first gas discharge device;
the second activation resistor is connected between the first terminal of the first gas discharge device and the reference potential line; and
the third activation resistor is connected between the second terminal of the first gas discharge device and the reference potential line.

39. A device according to claim 33, wherein the first conducting line is a first phase line and the second conducting line is a neutral line, and comprising a second phase line and a third phase line.

40. A device according to claim 39, comprising:
a second gas discharge device and a third gas discharge device; and
a second varistor and a third varistor;
and wherein:
the first gas discharge device, the second gas discharge device, and the third gas discharge device have respective first terminals connected to the first phase line via the first varistor, to the second phase line via the second varistor, and to the third phase line via the third varistor, respectively, and respective second terminals connected to the second conducting line.

41. A device according to claim 40, wherein:
the activation network comprises a second activation resistor and a third activation resistor;
the first activation resistor is connected between the first terminal and second terminal of the first gas discharge device;
the second activation resistor is connected between the first terminal and second terminal of the second gas discharge device; and
the third activation resistor is connected between the first terminal and second terminal of the third gas discharge device.

42. A device according to claim 40, comprising a fourth gas discharge device having a first terminal connected to the first terminal of the first gas discharge device, a second terminal connected to the first terminal of the second gas discharge device, and a third terminal connected to the first terminal of the third gas discharge device.

43. A device according to claim 40, comprising a fourth varistor and a reference potential line; and wherein third terminals of the first gas discharge device, of the second gas discharge device, and of the third gas discharge device are connected to the reference potential line via the fourth varistor.

44. A device according to claim 33, wherein the activation network comprises:
a booster device, having an output connected to one of the terminals of the first gas discharge device; and
a driving circuit, configured to drive the booster device in order to supply a voltage higher than the threshold voltage between the terminals of the first gas discharge device, when the input voltage exceeds the trigger voltage.
